(19) United States
(12) Patent Application Publication
(10) Pub. No.: US 2003/0155811 A1
(43) Pub. Date: Aug. 21, 2003

(54) Remote input/output device

(76) Inventor: Makoto Yoneya, Gamo-gun (JP)

Correspondence Address: D. PETER HOCHBERG CO. L.P.A., 1940 EAST 6TH STREET, CLEVELAND, OH, 44114, US

(21) Appl. No.: 10/365,267

(22) Filed: Feb. 11, 2003

(30) Foreign Application Priority Data
Feb. 20, 2002 (JP) 2002-042416

(51) Int. Cl. H02J 3/00; H02M 1/10; H02J 1/10

(52) U.S. Cl. 307/29

(57) ABSTRACT

A remote input/output device (1) has a plurality of connectors (CN) to be connected to input/output equipments (12) and is capable of performing transmission and reception, between the remote input/output device and a program controller (3) of the input/output equipments (12), of the input/output data to and from the input/output equipments (12), wherein it is arranged that two input/output points can be connected to each connector (CN), and that each input/output point is switchable between input and output points by an internal jumper switch. According to this arrangement, input/output points can be freely switched between input and output according to the number of input and output points. Thus, a single remote input/output device can serve for a necessary number of input/output points, allowing it to keep the man-hours of work and equipments-purchasing cost from increasing.

### BACKGROUND OF THE INVENTION

1. Field of the Invention

The present invention relates to a remote input/output device.

2. Description of the Prior Art

In electric work for a system (facility), the concentrated wiring system that makes a connection between each piece of input/output equipments (such as a switch or a relay excitation coil constituting the system) of the system and the control device (or control board) of the system by using multicore cables was mainstream. In recent years, however, with the progress of wiring-saving intended to reduce man-hours of work, a remote input/output device (remote I/O unit) has been frequently used for wiring-saving purposes. The remote input/output device is a device that has a plurality of input/output points connected to the input/output equipments of the system and effects transmission and reception of input/output data, between the remote input/output device and the control device, of the input/output equipments connected to these input/output points.

With known remote input/output devices, the number of input/output points and the common power supply fed to input/output equipments are fixed; as for the number of input/output points, “8 input points and 8 output points” or 16 input points or 16 output points are standardized, and as for the common power supply, 1 common for 8 I/O points or 1 common for 16 points is standardized.

With the arrangement of the known remote input/output device, however, since the number of input/output points is fixed, when it is desired to increase the input/output points as desired by the system, it is necessary to combine some remote input/output devices, thus increasing the cost for purchasing remote input/output devices and increasing the man-hours of electric work, leading to an increase in the cost of the entire system.

### SUMMARY OF THE INVENTION

Accordingly, an object of the invention is to provide a compact remote input/output device that solves these problems, satisfies desired input/output points without increasing the number of remote input/output devices while keeping the man-hours of work and equipments-purchasing cost from increasing, and cuts the man-hours for processing the wiring terminals through the use of connectors.

To achieve this object, the invention provides a remote input/output device that has a plurality of input/output points to be connected to input/output equipments and performs transmission and reception, between the remote input/output device and a control device, of the input/output data to and from the input/output equipments, wherein each input/output point is switchable between the input point and the output point.

According to such arrangement, the input/output points can be freely switched between input and output ill conformity with the number of input/output points to be connected, so that a necessary number of input/output points can be served by a single remote input/output device, making it possible to keep the number of man-hours of work and equipments-purchasing cost from increasing.

### BRIEF DESCRIPTION OF THE DRAWINGS

FIG. 1 is a structural diagram showing a system using a remote input/output device according to an embodiment of the invention;

FIG. 2 is a front view of the remote input/output device;

FIG. 3 is an internal perspective view of the remote input/output device;

FIG. 4a is a plan view of a communication board of the remote input/output device;

FIG. 4b is a plan view of a connector board of the remote input/output device;

FIG. 4c is a jumper switch of the remote input/out device;

FIG. 5 is a structural diagram of the remote input/output device;

FIG. 6 is a structural diagram of a circuit connected to the remote input/output device; and

FIG. 7 shows how jumper wires are connected in the remote input/output device, the jumper wires constituting the circuit of FIG. 6.

### DESCRIPTION OF THE PREFERRED EMBODIMENTS

An embodiment of the invention will now be described with reference to the drawings.

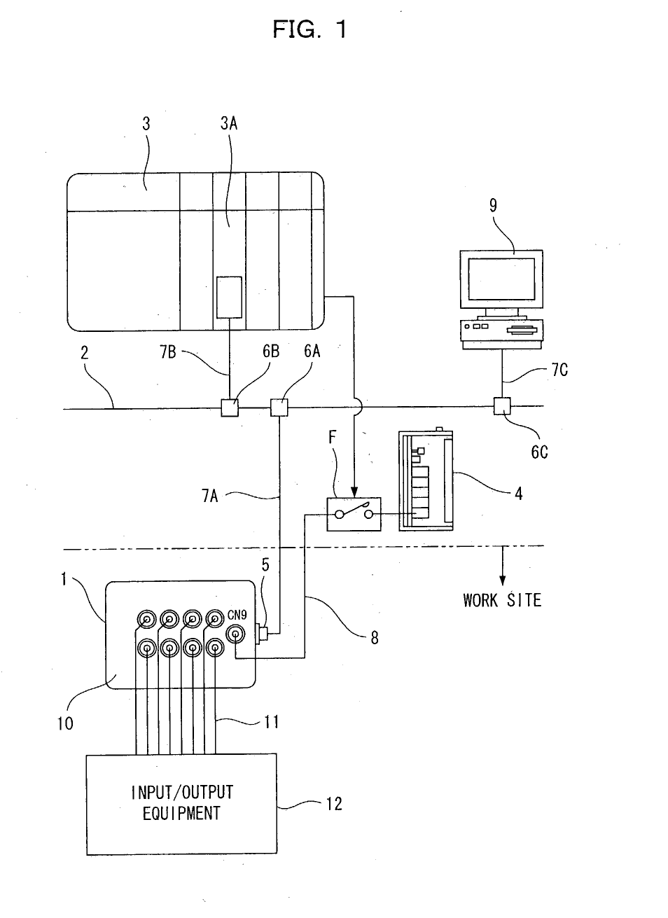

FIG. 1 is a structural diagram showing a system using a remote input/output device according to an embodiment of the invention.

In FIG. 1, the numeral 1 denotes a remote input/output device, and this remote input/output device 1 is connected to a program controller (an example of a control device for a system) 3 through a transmission line 2 and also to a constant voltage power supply device 4 through a circuit breaker F.

The numeral 5 denotes the communication connector of the remote input/output device 1. A connection between the communication connector 5 and an adaptor 6A of the transmission line 2 is made by a communication cable (multicore cable) 7A, and a connection between an adapter 6B of the transmission line 2 and a communication board 3A of the program controller 3 is made by a communication cable 7B, so that transmission and reception of data between the remote input/output device 1 and the program controller 3 can be performed through communication cables 7A, 7B, adaptors 6A, 6B and transmission line 2.

Further, a connection between a power supply connector CN9 of the remote input/output device 1 and the constant voltage power supply device 4 is made by a power supply cable 8 through the circuit breaker F, so that a DC power supply (IP common, OP common, N common) is fed to the remote input/output device 1 by the constant voltage power supply device 4 through the power supply cable 8.

In addition, the circuit breaker F is capable of separately turning on and off the IP common power supply and OP common power supply of the DC power supply manually or by signals from the program controller 3. Further, the circuit breaker F is normally in a turn-on state and separately turns off the IP common power supply and OP common power supply in response to signals from the program controller 3.

Further, a personal computer 9 is connected to an adaptor 6C of the transmission line 2 by a communication cable 7C, so that transmission and reception of data between the personal computer 9 and the program controller 3 is possible.

The front of a main body case 10 of the remote input/output device 1, as shown enlarged in FIG. 2, is provided with eight 4-terminal input/output (I/O) connectors CN1 through CN8, and 2 input/output points (the input point of a switch or the like and the output point of a relay excitation coil or the like) of input/output equipments 12 are connected to each of the input/output connectors CN1-CN8 through an input/output cable (for example, 4-core cable) 11. The program controller 3 corresponds to the control device of this input/output equipments 12.

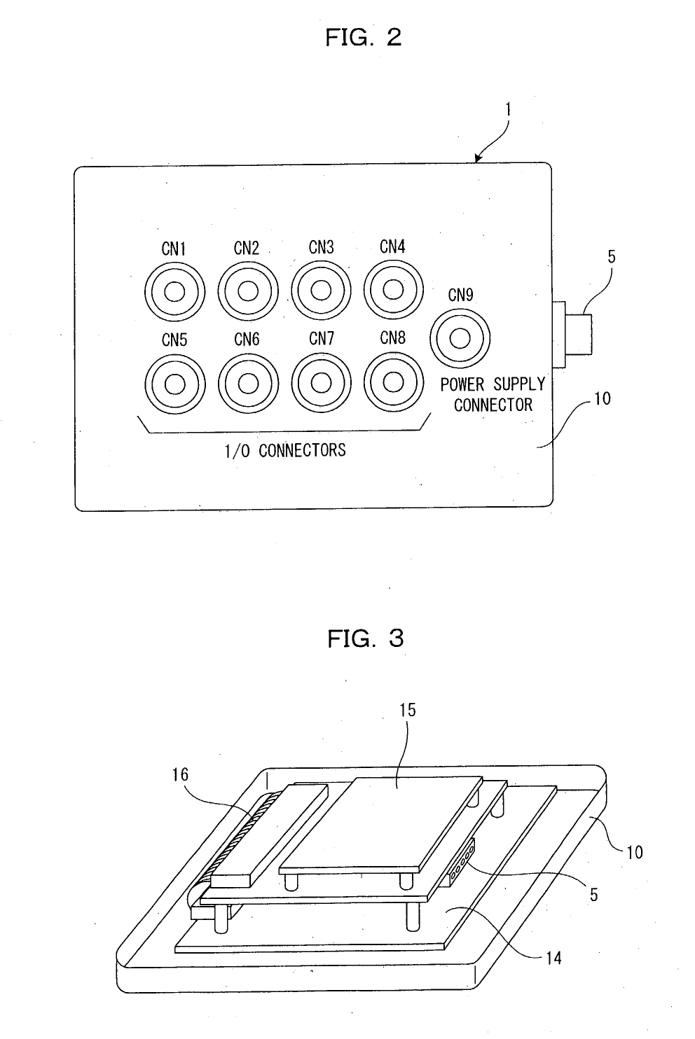

Further, installed in the main body case 10 of the remote input/output device 1, as shown in FIG. 3, is a communication board 15 for the second layer (data link layer) for transmission and reception of input/output data to and from the input/output equipments 12 between a connector board 14 having the input/output points of the input/output equipments 12 connected thereto through the input/output connectors CN1-CN8, and the program controller 3, these boards 14 and 15 being connected by a flat cable 16.

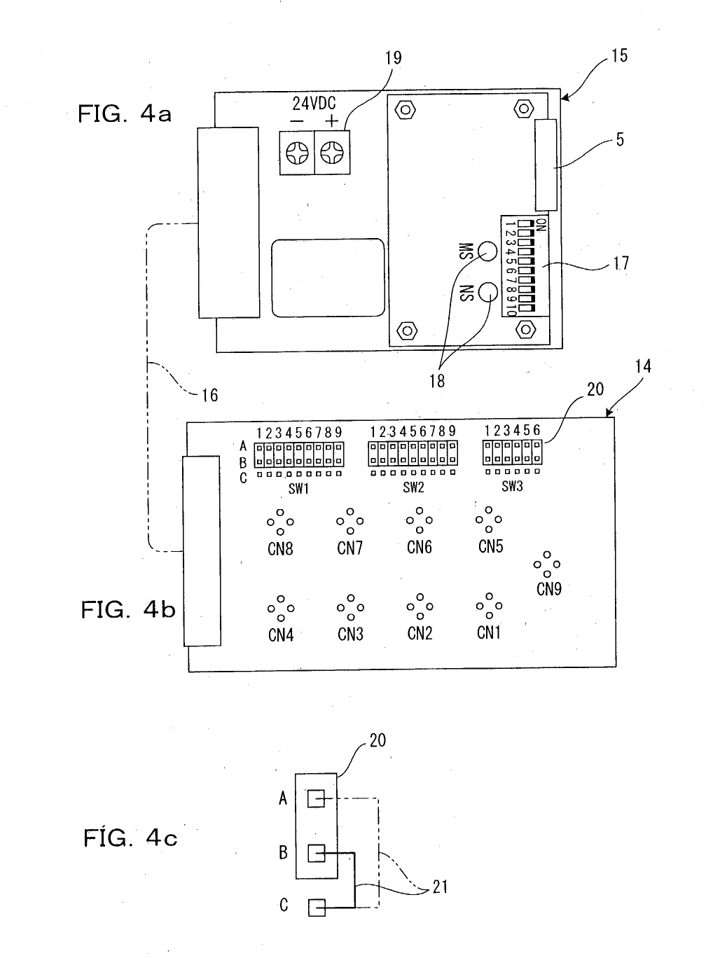

The communication board 15 forms a communication device capable of transmitting corresponding input/output data in a mixed state to the input/output points, and it is arranged that as shown in FIG. 4(a), “node address,” “communication speed,” and “selection of whether to hold or clear the output data during communication abnormality” are set by a dip switch 17 disposed on the front surface, and that normal operation, fault, communication abnormality or the like is indicated by a state lamp 18 disposed on the front surface. Further, the front surface of the communication board 15 is provided with a terminal block 19 that is connected to a power supply connector CN9, the communication board 15 being fed with electricity through the terminal block 19.

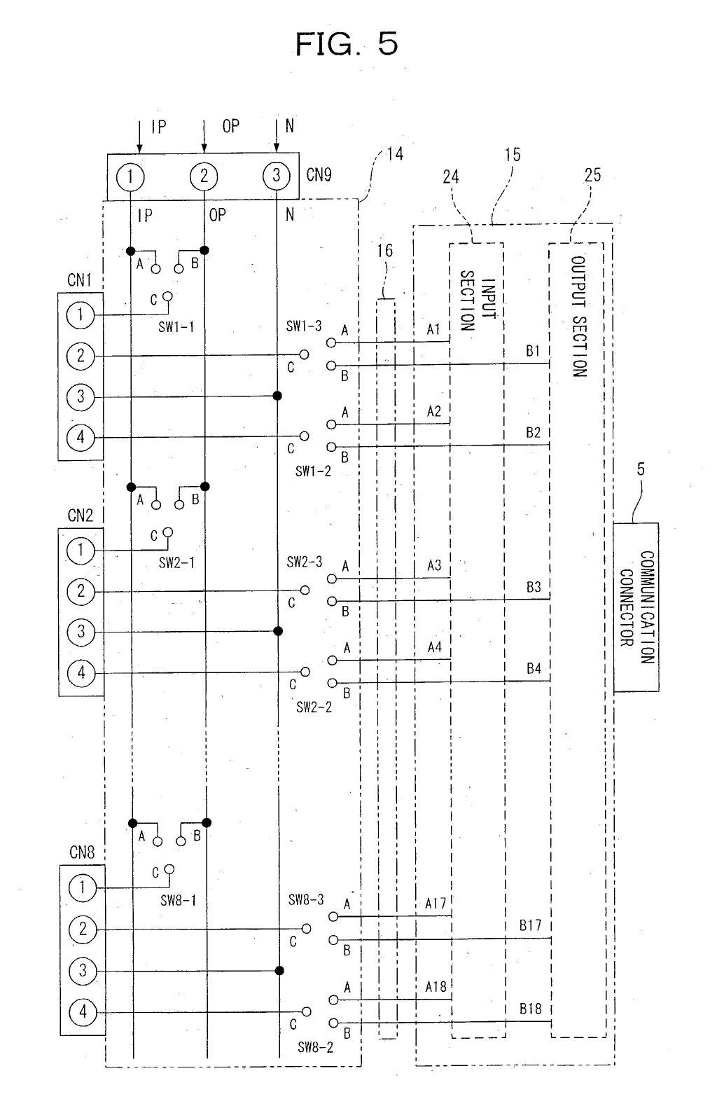

Further, the communication board 15, as shown in FIG. 5, is provided with an input section 24 for inputting the input data from the connector board 14 and an output section 25 for outputting output data into the connector board 14, so that the input data from the input/output equipments 12 is transmitted from the input section 24 of the communication board 15 to the program controller 3, and the output data outputted from the program controller 3 to the input/output equipments 12 is received from the program controller 3 to the output section 25 of the communication board 15.

Further, the front surface of the connector board 14, as shown in FIG. 4(b), is provided with 24 jumper switches 20. Each jumper switch 20 is composed of three terminals. As shown in FIG. 4(c), the jumper switch is a switch capable of connecting a common terminal C to a terminal A or a terminal B by a jumper wire 21, so that as shown in FIG. 4(c), electric conduction can be effected between the common terminal C and the terminal A or between the common terminal C and the terminal B. For each input/output point, these jumper switches 20 constitute a switch for connecting the input/output point to one of the input section 24 of the communication board 15 and the output section 25 of the communication board, and further a switch for selecting one of the plurality of common power supplies, i.e., the IP common power supply, OP common power supply, and N common power supply thereby to feed power to the input/output equipments 12.

Groups of three jumper switches 20 respectively correspond to the input/output connectors CN1 through CN8. The jumper switches 20 corresponding to the input/output connector CN1 are denoted by switches SW [1]-1, SW [1]-2 and SW [1]-3, the jumper switches 20 corresponding to the input/output connector CN2 are denoted by switches SW [2]-1, SW [2]-2 and SW [2]-3, and in like manner, the jumper switches 20 corresponding to the input/output connector CN8 are denoted by switches SW [8]-1, SW [8]-2 and SW [8]-3. The circuit arrangement of the connector board 14 is shown in FIG. 5.

Extended from the power supply connector CN9 are three power supply lines, i.e., an IP common power supply line, an OP common power supply line and an N common power supply line. The terminals A of the switches SW [1-8]-1 are connected to the IP common power supply line, the terminals B of the switches SW [1-8]-1 are connected to the OP common power supply line, and terminals \mathring{3} of the input/output connectors CN1-CN8 are connected to the N common power supply line.

Further, the common terminals C of the switches SW [1-8]-1 are respectively connected to terminals \mathring{1} of the input/output connectors CN1 through CN8, the common terminals C of the switches SW [1-8]-3 are respectively connected to terminals \mathring{2} of the input/output connectors CN1-CN8, and the common terminals C of the switches SW [1-8]-2 are respectively connected to terminals \mathring{4} of the input/output connectors CN1 through CN8.

Further, the terminals A of the switches SW [1-8]-3 and the terminals A of the switches SW [1-8]-2 are connected to the input section 24 of the communication board 15 through the flat cable 16, and the terminals B of the switches SW [1-8]-3 and the terminals B of the switches SW [1-8]-2 are connected to the output section 25 of the communication board 15 through the flat cable 16.

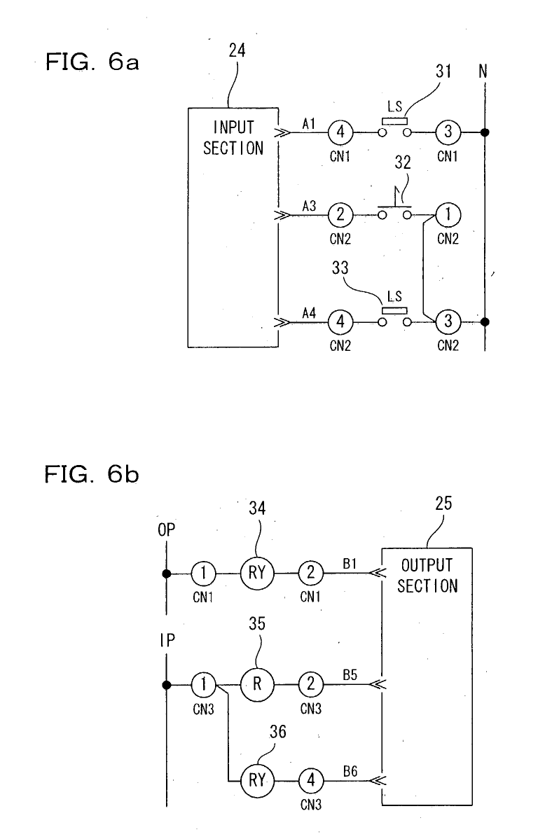

An example of connection of the jumper wire 21 in the connector board 14 will be described with reference to a case of connecting it to the input/output equipments 12 as shown in FIG. 6.

In FIG. 6, as input points, a first limit switch 31, an operating switch 32 and a second limit switch 33 of the input/output equipments 12 are connected to the remote input/output device 1 so as to take in actuation signals from these switches 31, 32 and 33, while as output points, a first relay 34, an indicator lamp 35 and a second relay 36 of the input/output equipments 12 are connected so as to output excitation signals to these relays 34 and 36, and to output an indication signal the indicator lamp 35. In addition, it is understood that input signals are taken in from the N common power supply line and are outputted to the first relay 34 by the OP common power supply line and to the indicator lamp 35 and second relay 36 by the IP common power supply line.

Further, it is understood that the first limit switch 31 and first relay 33 are connected to the input/output connector CN1, the operating switch 32 and second limit switch 31 are connected to the input/output connector CN2, and the indicator lamp 35 and second relay 36 are connected to the input/output connector CN3.

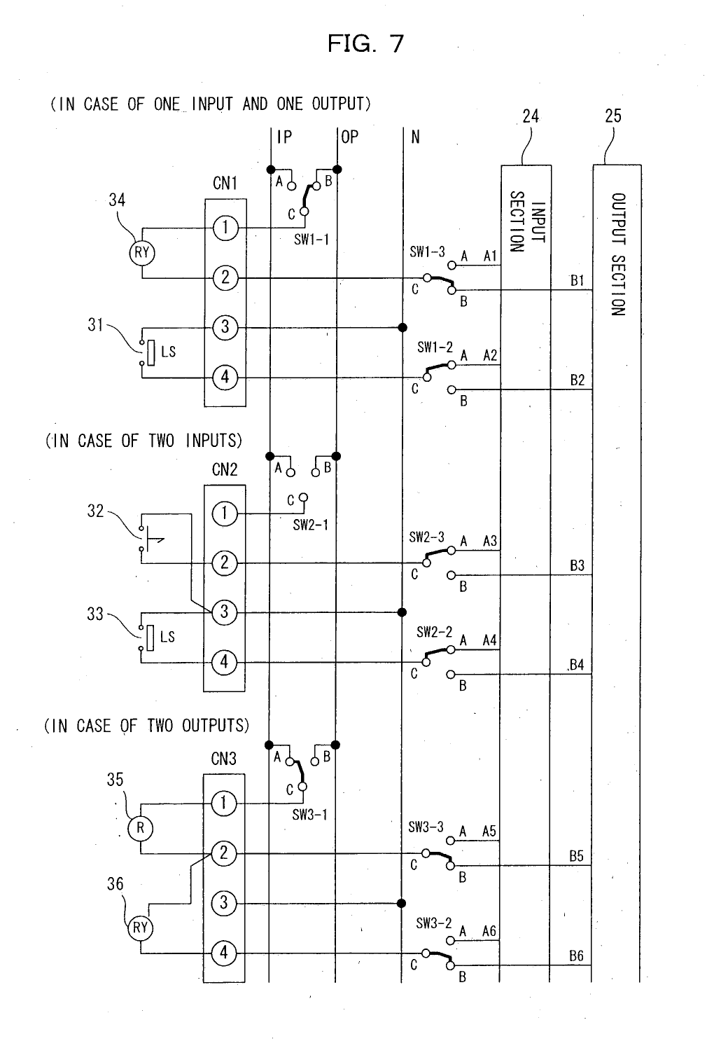

First, as shown in FIG. 7, the first relay 34 is connected between the terminals \mathring{1} and \mathring{2} of the input/output connector CN1, the first limit switch 31 is connected between the terminals \mathring{3} and \mathring{4}, the operating switch 32 is connected between the terminals \mathring{2} and \mathring{3} of the input/output connector CN2, the second limit switch 33 is connected between the terminals \mathring{3} and \mathring{4}, the indicator lamp 35 is connected between the terminals \mathring{1} and \mathring{2} of the input/output connector CN3, and the second relay 36 is connected between the terminals \mathring{2} and \mathring{4}.

Second, the common terminal C and terminal B of SW [1]-1 are connected by the jumper line 21, and the common terminal C and terminal B of SW [1]-3 are connected. Thereby, the OP common power supply line and the output section 25 are connected to the first relay 34.

Further, the common terminal C and terminal A of SW [1]-2 are connected by the jumper line 21. Thereby, the N common power supply line and input section 24 are connected to the first limit switch 31.

Further, the common terminal C and terminal A of SW [2]-3 are connected by the jumper line 21. Thereby, the N common power supply line and input section 24 are connected to the operating switch 32.

Further, the common terminal C and terminal A of SW [2]-2 are connected by the jumper line 21. Thereby, the N common power supply line and the input section 24 are connected to the second limit switch 33.

Further, by the jumper lines 21, the common terminal C and terminal A of SW [3]-1 are connected and the common terminal C and the terminal B of SW [3]-3 are connected. Thereby, the IP common power supply line and the output section 25 are connected to the indicator lamp 35.

Further, the common terminal C and the terminal B of SW [3]-2 are connected by the jumper line 21. Thereby, the IP common power supply line and the output section 25 are connected to the second relay 36.

Thus, switching by the jumper switches 20 enables the two input/output points of each of the input/output connectors CN1-CN8 to be freely connected to the input section 24 and the output section 25. Therefore, the two input/output points can be used as a combination of an input point and an output point, or as two input points or as two output points, and a total of 16 input/output points of the eight connectors CN can be used in free combinations of input points and output points. Thus, possibility that necessary input/output points can be connected by the single remote input/output device 1 increases, allowing it to cut down the number of man-hours for processing the wiring terminals, to reduce equipments-purchasing cost as compared with commercially available products, and to save installation space (economization in space). Further, it is possible to reduce time for designing and drawing plan views.

Further, the common power supply for feeding power to the input/output equipments 12 can be selected from the IP common power supply and OP common power supply, whereby it is possible to divide the input/output equipments 12 into two lines to be fed from another common power supplies respectively. That is, the power supply can be divided into two lines, and by turning on and off the common power supply for each line by the circuit breaker F, maintenance can be effected separately for each line. Further, if an abnormality occurs in one line, enlargement of the abnormality in the one line can be prevented by turning off the power supply in the one line by actuating the circuit breaker F while keeping alive the power supply in the other line by the program controller 3. For example, when the power supply in one line is used as a power supply for input/output for a motor or the like of a controlling/driving system, while the power supply in the other line is used as a power supply for input/output associated with safety/interlocking/alarming, the program controller 3 actuates the circuit breaker F to turn off the power supply in the one line when it is decided that an abnormality has occurred in this one line of the controlling/driving system, whereby an abnormal operation in the controlling/driving system can be prevented. Further, at this time, since the power supply in the other normal line can be maintained, it becomes possible to maintain the operation of warning means such as the lamp 35 and to maintain the input/output for safety and interlocking.

Further, if there were only one line of common power supply in the remote input/output device as in a prior art, remote input/output devices corresponding to the number of lines would have to be installed separately for each line in order to make it possible to turn off the common power supplies separately in consideration of the relation of the safety and interlocking. However, since there are two lines of common power supply, it becomes possible to reduce the number of remote input/output devices 1, to reduce the equipments-purchasing cost, and to save the installation space (economization in space). Further, it is possible to reduce the time for designing and drawing plan views.

Further, the use of the communication connector 5, the input/output connectors CN1 through CN8 and the power supply connector CN9 for effecting connection by connectors facilitates the connection of the cables 7A, 8 and 11 to the remote input/output device 1, thus achieving labor saving.

In the above embodiment, plus power supplies are used as IP common power supply and OP common power supply in two lines. However, it is also possible to use a minus N common power supply in both two lines. Further, it is also possible to divide the two lines into lines each provided with a plurality of power supplies, and to select a power supply for feeding power to each of such lines.

In the above embodiment, the transmission and reception of input/output data between the remote input/output device 1 and the program controller 3 have been performed through the transmission line 2, adapters 6A and 6B, and communication cables 7A and 7B. However, it is also possible to effect the transmission and reception of input/output data by using light or electric waves.

Further, in the above embodiment, the jumper switches 20 are installed inside the remote input/output device 1. However, they may be installed on the surface of the main body case 10 of the remote input/output device 1 to make it possible to switch the input/output points without opening the case 10.

What is claimed is:

1. A remote input/output device having a plurality of input/output points to be connected to input/output equipments, and performing transmission and reception, between the remote input/output device and a control device, of input/output data to and from each of said input/output equipments, wherein
each of the input/output points is switchable between the input point and the output point.

2. The remote input/output device as set forth in claim 1, wherein at least two kinds of common power supplies for feeding power to the input/output equipments can be selected.

3. The remote input/output device as set forth in claim 1, wherein connection to the input/output equipments is effected by connectors.

4. A remote input/output device having a plurality of input/output points to be connected to input/output equipments, and performing transmission and reception, between the remote input/output device and a control device, of input/output data to and from the input/output equipments, wherein
the remote input/output device comprises:
a communication board capable of transmitting and receiving, between the communication board and the control device, the input/output data in a mixed state; and
a connector board to which the input/output equipments are connected,
said communication board being provided with an input section for inputting input data from the connector board and an output section for outputting output data to the connector board,
said connector board is provided with switches, respectively for said input/output points, for connecting the input/output point to one of the input section and the output section of the communication board.

5. The remote input/output device as set forth in claim 4, wherein the connector board is provided with switches respectively for selecting one from a plurality of common power supplies and feeding power therefrom to the input/output equipments.
